(19) United States
(12) Patent Application Publication
(10) Pub. No.: US 2025/0296521 A1
(43) Pub. Date: Sep. 25, 2025

(54) DRIVERLESS TRANSPORT DEVICE COMPRISING A SELF-DRIVING VEHICLE FOR TRANSPORTING A RECEIVING CONTAINER FOR A SLIVER

(71) Applicant: TRÜTZSCHLER GROUP SE, Mönchengladbach (DE)

(72) Inventor: Johannes BOSSMANN, Sonsbeck (DE)

(73) Assignee: TRÜTZSCHLER GROUP SE, Mönchengladbach (DE)

(21) Appl. No.: 18/863,995

(22) PCT Filed: May 5, 2023
(86) PCT No.: PCT/EP2023/062018

§ 371 Date: Nov. 7, 2024

(30) Foreign Application Priority Data
May 10, 2022 (DE) 10 2022 111 675.1
May 24, 2022 (EP) 22175157.1

(51) Int. Cl. B60R 19/48; B60L 53/16; B60R 19/02; B62D 63/04; B65H 67/06

(52) U.S. Cl. CPC B60R 19/483; B60L 53/16; B60R 19/023; B62D 63/04; B65H 67/06

(57) ABSTRACT

A driverless transport device having a self-driving vehicle for transporting a receiving container for a fibre sliver between sliver-delivering and sliver-fed textile machines. The vehicle has an undercarriage with a plurality of wheels, a vehicle body supported by the undercarriage and having a transport surface for the receiving container, fastening elements for fastening the receiving container to the vehicle body, and an on-board electrical system having an electrical energy storage means, an electrical drive unit and a control unit. A safety device for impact detection. is arranged on the vehicle and is in signalling communication with the control unit and for generating a switching signal on impact with an obstacle. The vehicle is dimensioned so that, in an installed state, the receiving container is fastened to the vehicle body in contact with the transport surface and entirely covers the undercarriage, the electrical drive unit and the electrical energy storage means.

### CROSS-REFERENCE TO RELATED APPLICATIONS

This application is a U.S. National Stage of International application PCT//EP2023/062018 filed May 5, 2023, which claims priority from German Application DE 10 2022 111 675.1 filed May 10, 2022, and European Application EP 22175157.1, filed May 24, 2022.

### BACKGROUND OF THE INVENTION

The present invention relates to a driverless transport device having a self-driving vehicle for transporting a receiving container for a fibre sliver over an underlying surface between sliver-delivering and sliver-fed textile machines, the vehicle having an undercarriage with a plurality of wheels, a vehicle body which is supported by the undercarriage and has a transport surface for the receiving container, fastening elements for fastening the receiving container to the vehicle body, and an on-board electrical system having an electrical energy storage means, an electrical drive unit and a control unit, which electrical system is arranged on the vehicle body, and a safety device for impact detection which is arranged on the vehicle, the safety device being in signalling communication with the control unit and generating a switching signal on impact with an obstacle.

In spinning rooms there are customarily used several hundreds of sliver cans, also known as spinning cans or simply cans, which have hitherto predominantly still been moved between the textile machines by hand. This involves a large amount of manpower. In order to reduce the manpower involved, attempts have already been made for decades to automate the transport of the cans.

Chinese Patent CN 113668102 A discloses a self-driving vehicle for transporting sliver cans. The vehicle has a base which is constructed on an undercarriage equipped with stepping motors. The base is equipped with a rotationally drivable can placement region on which a sliver can be set down and, if required, rotated about the can axis. The can placement region is surrounded by an annular rim of the base from which a supporting structure projects in a vertical direction, on the upper end of which a robot arm having a left and a right side arm is provided. The two side arms form a bow-shaped structure for holding and receiving the sliver can. The left and right side arms are each provided with a control circuit, and both control circuits are connected to a controller which controls the picking-up and setting-down of the sliver can by the robot arm. Furthermore, the robot arm is said to be configured with six degrees of freedom, which consists of an arm, an elbow and a hand element connected in series and which can be adjusted flexibly in order to pick up and set down the sliver can as required.

European Patent EP 0 412 463 A2 discloses a safety device for a driverless transport vehicle having an open transport surface for receiving a can for spun fibres, which can stand on feet. The transport surface has a raisable and lowerable platform for receiving the can. The safety device has at least one resiliently mounted switching strip which, in a load securing position, extends vertically substantially over the height of the can and is associated with an edge of the can that is located in the rearward region of the vehicle, in order to generate a switching signal for stopping the vehicle in the event of impact with an obstacle in the region of the can that is resting on the vehicle

### SUMMARY OF THE INVENTION

An object of the present invention is to provide a driverless transport device which enables personnel to be protected in a less complex and easier-to-handle way.

The above and other objects are achieved in a driverless transport device of the kind mentioned at the beginning by the vehicle's being dimensioned in such a way that in an installed state, in which the receiving container is in contact with the transport surface and is fastened to the vehicle body, the receiving container entirely covers the undercarriage, the electrical drive unit and the electrical energy storage means.

It is advantageous that in the installed state the driverless transport device is protected by the receiving container and neither the undercarriage nor the electrical drive unit nor the electrical energy storage means project beyond the receiving container. The driverless transport device therefore requires only the same amount of space as a conventional sliver can, that is to say a manually moved sliver can. As a result, the safety device for impact detection can have a less complex design. On impact with the obstacle, the safety device generates the switching signal. Preferably, the control unit stops the vehicle after receiving the switching signal. The risk of accidents involving personnel or material damage is thereby reduced.

Where spatial details, such as “top”, “bottom”, “above” and “below” are used, they are intended merely to describe the relative arrangement of the components in question. Those details relate to the vehicle when its wheels are standing on the underlying surface. The vertical axis of the vehicle is then normal to the underlying surface. The underlying surface can be a factory floor in the spinning room, on which the textile machines can be situated, a fixed ramp for bridging differences in height, a floor of a can changer of the textile machine or the like. The sliver-delivering and sliver-fed textile machines can be, for example, spinning room preparation machines, such as draw frames, carding machines, combing machines, lap-winding machines and the like, and/or spinning room machines, such as rotor spinning machines, air spinning machines, flyers and the like.

In a further configuration, the vehicle can be dimensioned in such a way that in the installed state the receiving container entirely covers the vehicle body. As a result, in the installed state the driverless transport device, like a conventional sliver can, that is to say a manually moved sliver can, is able to access working areas of the textile machines, such as a filling station on a can changer or the like, and can accordingly also be used for performing movements in the working areas. For example, the driverless transport device can be rotated together with a can rotary plate of the textile machine or, by virtue of the drivable undercarriage, is itself able to rotate below a coiler plate of the textile machine.

In particular, the transport surface can define a support plane. Preferably, the vehicle has no components that project beyond the support plane outside the transport surface. It is advantageous that accordingly no components coming from below, that is to say coming from the undercarriage, project laterally past the transport surface and upwards beyond the support plane. In particular, “laterally of the transport surface” is to be understood as radially outside the transport surface in relation to the vertical axis of the vehicle. In that way the vehicle has no troublesome components, such as edges, mountings, bars, loading and unloading devices or the like laterally of the transport surface, with the result that the receiving container to be transported can be simply set down on the vehicle to establish the installed state. The transport surface preferably lies in the support plane, which can be aligned parallel to the underlying surface. Inside the transport surface, that is to say that surface which is in contact with the receiving container in the installed state, there can be provided fastening elements, which are in principle also able to project beyond the support plane, for example bolts, screws or the like.

In accordance with one embodiment, the transport device can comprise the receiving container which is mounted on the transport surface of the vehicle and is fastened to the vehicle body, the receiving container entirely covering the undercarriage, the electrical drive unit and the electrical energy storage means and especially the vehicle body. In that installed state, the receiving container also contributes to the protection of an obstacle, such as a person or some other object standing in the route of the driverless transport device, in front of the vehicle. In the installed state, the driverless transport device externally largely corresponds to a standard can, that is to say a conventional manually moved sliver can. With the receiving container installed, the transport device can also be referred to as a self-driving can device.

In particular, the vehicle is dimensioned relative to the receiving container, that is to say provided with an extent perpendicular to a vertical axis which is fixed relative to the vehicle, in such a way that the space requirement or functional surface area of the vehicle during operation is at least substantially limited to the size of the footprint or cross-sectional area of the receiving container. The footprint of the receiving container, detached from the vehicle, is understood to be that floor area of the underlying surface which is required for the receiving container in the mounted state, irrespective of whether or not the container is touching the underlying surface. The functional surface area of the vehicle is that floor area of the underlying surface which is covered by the vehicle during operation. The overall size of the vehicle is dimensioned such that the vehicle is at least substantially accommodated below the receiving container when the latter is in contact with the transport surface and is fastened to, or installed on, the vehicle by means of the fastening elements (=installed state). “At least substantially” is intended to include the vehicle's being arranged virtually entirely underneath the receiving container in the installed state, with only individual components, especially from the on-board electrical system, being able to project laterally beyond the receiving container if there is a technical necessity therefor. In principle, however, it is also possible for the whole vehicle to be entirely covered by the receiving container. The undercarriage, the electrical drive unit and the transport surface are accordingly located below the receiving container in the installed state and are therefore concealed by the receiving container in a plan view from above. Consequently the vehicle is configured for transporting only the one receiving container.

Preferably, the vehicle carries the receiving container, which is correspondingly spaced apart from the fixed underlying surface. Advantageously, the on-board electrical system is also covered by the receiving container, although there may be technical requirements which mean that individual components are to be arranged also outside the region covered by the receiving container. For example, such a component may be the radio module in order to improve the quality of the radio connection to a higher-level master controller.

In particular, the receiving container has a filling space with a filling opening, which is open towards the top, for the fibre sliver. In the case of a receiving container in the form of a “round can”, the footprint can be circular and in the case of a “rectangular can” accordingly rectangular.

Furthermore, the receiving container can be mounted on the transport surface and fastened to the vehicle by means of the fastening elements in such a way that a container axis of the receiving container and the vertical axis of the vehicle coincide. The driverless transport device therefore does not swing out during rotation, with the result that protection of personnel is further improved. In particular, the vertical axis of the vehicle coincides with the yaw axis of the vehicle, so that the vehicle and therefore also the whole driverless transport device is able to turn on the spot.

Moreover, the driverless transport device can comprise a bumper. The bumper can be fastened to the receiving container or to the vehicle. In accordance with one configuration, the bumper can be arranged on a container wall that encloses the filling space of the receiving container. In accordance with a further configuration, the bumper can be fastened to a collar of the vehicle.

Preferably, the bumper is arranged in such a way that it projects, facing outwards, beyond the receiving container, i.e. the receiving container to be transported. In other words, the bumper projects away from a central axis of the can, or away from the vertical axis of the vehicle, beyond the receiving container. In the event of a collision with the obstacle, the driverless transport device accordingly first strikes the obstacle with its bumper. In particular, the bumper extends in the circumferential direction around the vertical axis of the vehicle or the axis of the can. The driverless transport device can also have a plurality of such bumpers which can be arranged one above the other along the vertical axis of the vehicle and fastened to the receiving container and/or to the vehicle.

The bumper can have a damping element made of a flexible material, which damping element extends in the circumferential direction around a yaw axis of the vehicle. The damping element can be a piece of flexible material, a layer of flexible material or the like. The damping element can be, for example, a rubber profile which, by virtue of its flexibility, can be attached to the side wall of the receiving container or to the vehicle from the outside. Furthermore, the whole bumper can be configured so as to be as flexible as possible in order that on impact with the obstacle it can largely absorb the impact momentum.

Furthermore, the safety device can have a contact sensor which is arranged in the bumper. In particular, the contact sensor can be arranged in the damping element. As a result, the bumper can be configured as a kind of sensor bar or as a safety strip, the compression of which caused by impact with the obstacle triggers the switching signal.

In accordance with a first configuration, for generating the switching signal the contact sensor can comprise a normally-open contact which is configured to close a contact in the event of collision with the obstacle. For that purpose, wires, especially non-insulated conductors, or contact strips can run in the bumper and preferably in the interior of the damping element, which wires or strips can be connected to inputs/outputs of the control unit. In the event of impact with the obstacle, the wires or contact strips are compressed locally, resulting in a contact that triggers the switching signal, so that due to the change in electrical resistance the control unit registers the impact with the obstacle and can initiate further measures, such as the stopping of the vehicle.

In accordance with a second configuration, for generating the switching signal the contact sensor can comprise a normally-closed contact which is configured to open a contact in the event of collision with the obstacle. For that purpose, a pre-tensioned chain can be located in the interior of the damping element, which chain comprises plastics parts and contact discs. On contact, the pre-tensioned assembly of plastics elements is disturbed and the contact discs between the plastics elements lose their electrical connection. The chain can be connected to the input/and output of the control unit. The contact interruption caused by the collision is recognised by the control unit, so that the latter can initiate further measures, such as the stopping of the vehicle.

Furthermore, it can be provided that the wheels define a wheel contact plane, the bumper being arranged at a spacing of at least 10 millimetres and at most 40 millimetres above the wheel contact plane. The collision can accordingly be reliably detected.

Furthermore, the bumper can have a c-shaped open ring shape having two ring ends in the circumferential direction around the vertical axis of the vehicle, it being possible for a charging interface for charging the energy storage means to be arranged between the ring ends. The contact sensor preferably extends only over the bumper and is therefore not provided in the region of the charging interface. This facilitates docking to a charging station for charging the energy storage means. The charging interface could, however, also be arranged in the region covered by the receiving container and especially arranged on the underside of the vehicle. In that case, for charging, the vehicle could “pass over” the connection contacts of the charging interface. It is likewise possible for inductive charging of the energy storage means to be provided.

In particular, the charging interface projects laterally beyond the bumper and is arranged in a dimensionally stable electrical housing, it being possible for an end face of the electrical housing to be concavely curved. The curvature of the end face is shaped so as to be at least approximately the same as, but opposite to, the curvature of a side wall of the receiving container. This is advantageous if the driverless transport device comes into contact with another driverless transport device or with a standard can, because the other can will be able to rest against the curved end face. This can be advantageous, for example, in a can changer if the driverless transport device is pushed against another can (“can against can” principle). Furthermore, an on/off switch can be arranged on the electrical housing so as to be accessible from the outside in order that the power supply between the energy storage means and the other components of the on-board electrical system can be interrupted manually. Instead of the c-shaped configuration, the bumper can also be in the form of a closed ring.

In order to recognise whether the driverless transport device has collided with an obstacle, it is further possible for monitoring of the axial moments of the driven wheels to be provided. This because, in the absence of collision detection, in the event of impact with an obstacle the control unit would increase the axial moments in order to overcome the resistance. The additional monitoring of the axial moments can accordingly reduce the risk of damage to the driverless transport device and to the obstacle. The user can himself determine the procedure after a collision; by default the control unit is configured in such a way that the vehicle immediately stops. In particular, the control unit is configured to monitor a power consumption of the drive unit and to stop the drive unit if a defined threshold value is exceeded.

The safety device can comprise further sensors for impact detection, such as, for example, acceleration sensors.

The self-driving vehicle can be an autonomous floor conveyor vehicle (“automated guided vehicle”, abbreviated to “AGV”, or “automated mobile robot”, abbreviated to “AMR”) for transporting the receiving container, which vehicle can travel along fixed specified paths or can be driven freely, that is to say without fixed track guidance. In preferred manner, the driverless transport device has no loading aids for loading and unloading the receiving container. Rather, the driverless transport device is of modular construction and comprises the self-driving vehicle and the receiving container as modules. The modular construction enables the production costs to be reduced, because the vehicle and the receiving container can be produced separately from one another and even by different manufacturers. The vehicle is “married” to the one receiving container and remains permanently connected thereto (=installed state). Preferably, separation is necessary only in the event of the vehicle's being defective or for maintenance purposes. The purpose of such a permanent connection is that the loading and unloading of the receiving container from the vehicle, which is regarded as disadvantageous, is not required. The fastening of the receiving container to the vehicle is an installation step that is preferably carried out manually, but which can in principle also be carried out by an industrial robot.

### BRIEF DESCRIPTION OF THE DRAWINGS

Preferred embodiments are explained below with reference to the Figures in the drawings, wherein:

FIG. 1 shows a front view of a driverless transport device in accordance with a first embodiment of the present invention situated on an underlying surface, the driverless transport device being of modular construction and having a receiving container according to the invention and a vehicle according to the invention for transporting the receiving container over the underlying surface;

FIG. 2 shows a rear view of the driverless transport device from FIG. 1;

FIG. 3 shows a simplified sectional view of the driverless transport device from FIG. 1;

FIG. 4 shows a sectional view of the receiving container from FIG. 1;

FIG. 5 shows the receiving container from FIG. 1 in a view from below;

FIG. 6 shows a plan view of the vehicle from FIG. 1, wherein, merely to illustrate the relative sizes, a base of the receiving container is indicated by a dotted line;

FIG. 7 shows the vehicle from FIG. 1 in a view from below, wherein, merely to illustrate the relative sizes, a base of the receiving container is indicated by a dotted line;

FIG. 8 shows a cross-sectional view of the vehicle from FIG. 1, wherein the vehicle is shown on the underlying surface;

FIG. 9 shows a diagrammatic view of an on-board electrical system of the vehicle from FIG. 1;

FIG. 10 shows a bumper having an integrated contact sensor of the driverless transport device from FIG. 1;

FIG. 11 shows an alternative embodiment of the contact sensor;

FIG. 12 shows a further alternative embodiment of the contact sensor; and

FIG. 13 shows part of a driverless transport device in accordance with a further embodiment of the present invention in a simplified sectional view.

### DETAILED DESCRIPTION

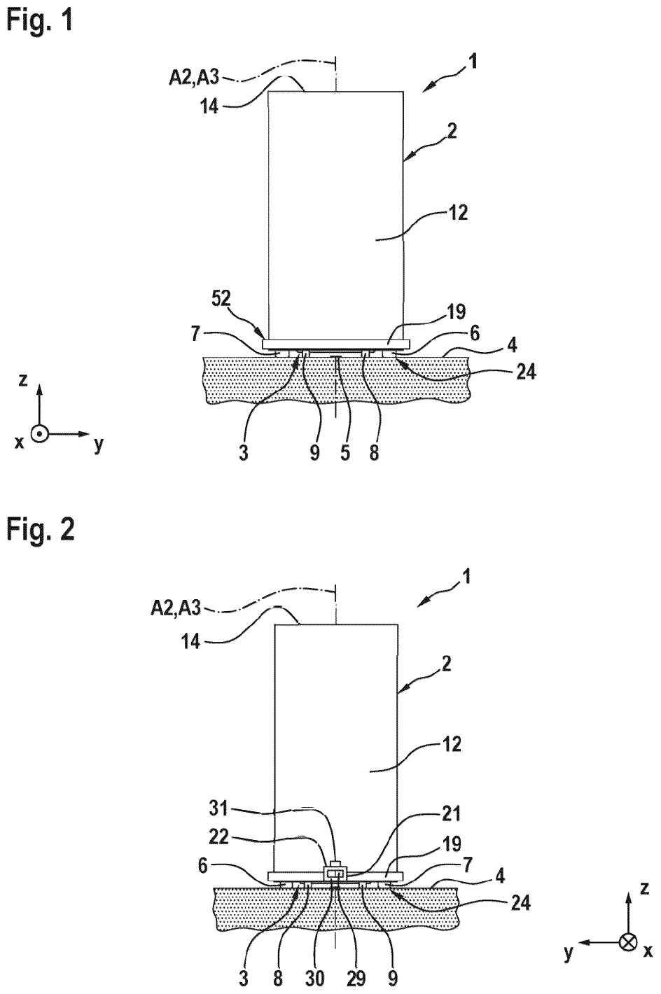

FIGS. 1 to 3 show a driverless transport device 1 in accordance with an embodiment of the present invention. The driverless transport device 1 is of modular construction and always has a self-driving vehicle 3 according to the invention for transporting a receiving container 2 for a fibre sliver over an underlying surface 4. As a further module, the transport device in the embodiment shown herein comprises the receiving container 2 according to the invention.

During operation, the driverless transport device 1 travels back and forth on the underlying surface 4 between textile machines (not shown) in order to transport fibre slivers from sliver-delivering textile machines to sliver-fed textile machines. For that purpose, the vehicle 3 is able to follow guide elements 5 which are arranged on the underlying surface 4 and specify routes in the spinning room. As shown in FIGS. 1 to 3, the guide elements 5 can have been applied, especially adhesively bonded, to the surface of the underlying surface 4 or can be embedded in the underlying surface 4. For example, slots and/or apertures of some other shape can be formed in the underlying surface 4, in which the guide elements 5 can be installed and then covered with epoxy resin or the like.

In order to illustrate the orientation of the driverless transport device 1 in space, FIGS. 1 to 3 show a longitudinal direction X, a transverse direction Y and a vertical direction Z which are defined in terms of a Cartesian coordinate system assigned to the driverless transport device 1 and indicated by corresponding arrows. The vertical direction Z can be normal to a floor plane defined by the underlying surface 4 when the driverless transport device 1 is standing or travelling on the underlying surface 4. Terms such as “bottom”, “below”, “top” or “above” are spatial details relating to the driverless transport device 1 situated on the underlying surface 4.

The vehicle 3 has been installed in the receiving container 2 from below, its wheels 6, 7, 8, 9 projecting on a container underside 10 of the receiving container 2. For sufficient ground clearance, a spacing S2 between the receiving container 2 and the underlying surface 4 is between 10 millimetres and 50 millimetres, with especially good results having been obtained with a spacing S2 of about 20 millimetres.

The receiving container 2 is in principle detachable but is permanently connected to the vehicle 3. That state is also referred to as the “installed state” and is shown in FIGS. 1 to 3. Specifically, fastening means 11 are provided which are not accessible from the outside unless the driverless transport device 1 is placed “on its head”. In that respect the fastening means 11 can also be referred to as internal fastening means which provide a blind fastening.

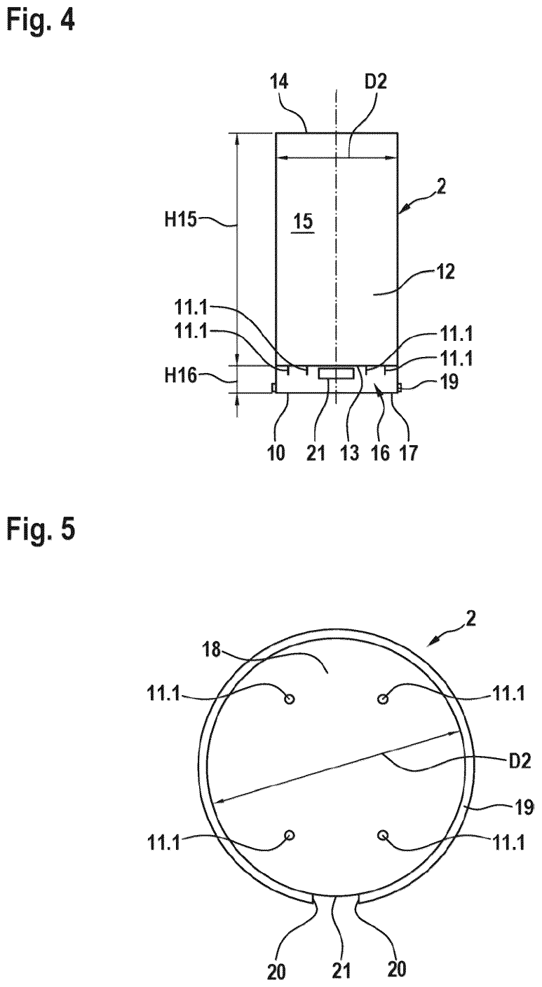

FIGS. 4 and 5 show the receiving container 2 according to the invention in detail. The receiving container has a cylindrical side wall 12 which extends concentrically around a container axis A2 that runs parallel to the vertical axis Z. An internal diameter D2 of the interior space enclosed by the side wall 12 is at least 350 millimetres and at most 1200 millimetres and is, here by way of example, 500 millimetres. Furthermore, the receiving container 2 has a supporting structure 13, which is here configured as a fixed container base in the form of a circular disc, the external diameter of which corresponds at least substantially to the internal diameter D2. The supporting structure 13, which is also referred to as the container base hereinbelow, is arranged in a recessed position and is rigidly connected to the side wall 12. “Arranged in a recessed position” means here that the container base 13 is arranged displaced away from the container underside 10 towards an upper side of the receiving container 2, which upper side is provided with a filling opening 14. The container base 13 therefore divides the interior space into a filling space 15, which is open towards the top, and an equipment space 16, which is open towards the bottom. By means of the filling opening 14, the fibre sliver can be introduced into the filling space 15 and removed again therefrom in a manner known per se. In the filling space there can be arranged, for example, a plate known per se (not shown) which can be, for example, spring-loaded and which is able to sink down towards the container base 13 under the weight of the column of fibre sliver that accumulates during the coiling. On the container underside 10 there is provided a container opening 17 which can be aligned parallel to the filling opening 14 and through which the vehicle 3 can be installed in the equipment space 16 from below. An internal diameter of the container opening 17 can correspond to the internal diameter D2 of the interior space, although in principle it can also be smaller, provided that the vehicle 3 can still be installed in the equipment space 16.

The equipment space 16 has an extent H16 in the vertical direction Z of, for example, at least 50 millimetres and at most 260 millimetres and has, here by way of example, an extent of 110 millimetres. The filling space 15 has an extent H15 in the vertical direction Z of, for example, at least 400 millimetres and at most 1500 millimetres and has, here by way of example, an extent of 1200 millimetres. Accordingly, the filling volume of the filling space 15 is, here, about 339 litres.

In the installed state, the receiving container 2 is supported by its container base 13 on the vehicle 3. For fastening the receiving container 2 to the vehicle 3, the fixing means 11 comprise container-side fastening elements 11.1, which have, for example, threaded bolts 11.1 aligned parallel to the container axis A2, onto which nuts 11.3 can be screwed. The, here by way of example four, threaded bolts 11.1 can be formed integrally with, especially welded to, a base underside 18 of the container base 13, which base underside faces towards the equipment space 16, as can be seen in the view from below according to FIG. 5.

Furthermore, a bumper 19 is arranged on the receiving container 2. The bumper is arranged in the circumferential direction around the container axis A2 on the outer side of the side wall 12. The bumper 19 is fastened to the receiving container 2 and can, for example, be screwed and/or adhesively bonded to the side wall 12. The bumper 19 is arranged at a spacing of at least 10 millimetres and at most 40 millimetres above the wheel contact plane E.

In FIG. 5 it can also be seen that the bumper 19 has a c-shaped open ring shape having two ring ends 20. A wall opening 21 is formed in the side wall 12 between the two ring ends 20, which wall opening is located on the rear side of the receiving container 2. FIG. 2 shows the rear view of the driverless transport device 1, from which it can be seen that an electrical housing 22 of the vehicle 3 extends through the wall opening 21 and projects laterally beyond the bumper 19. Alternatively, the bumper 19 can also be arranged on the vehicle 3 if the receiving container 2 is designed in the form of a sleeve where the container underside 10 of the receiving container 2 finishes flush with the container base 13. The alternative embodiment is shown in FIG. 13 and will be discussed in greater detail hereinbelow.

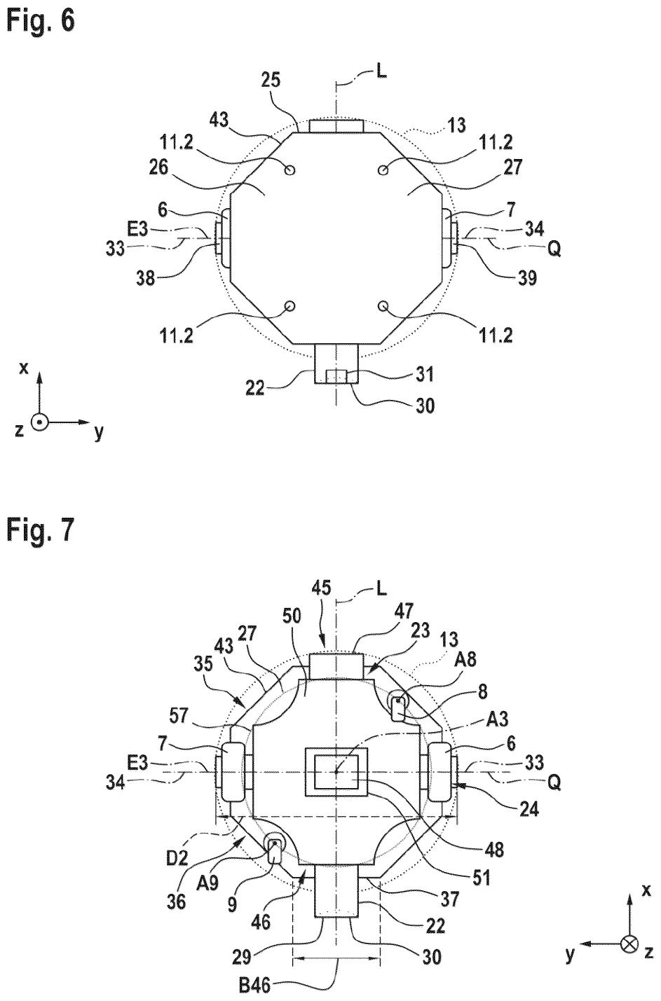

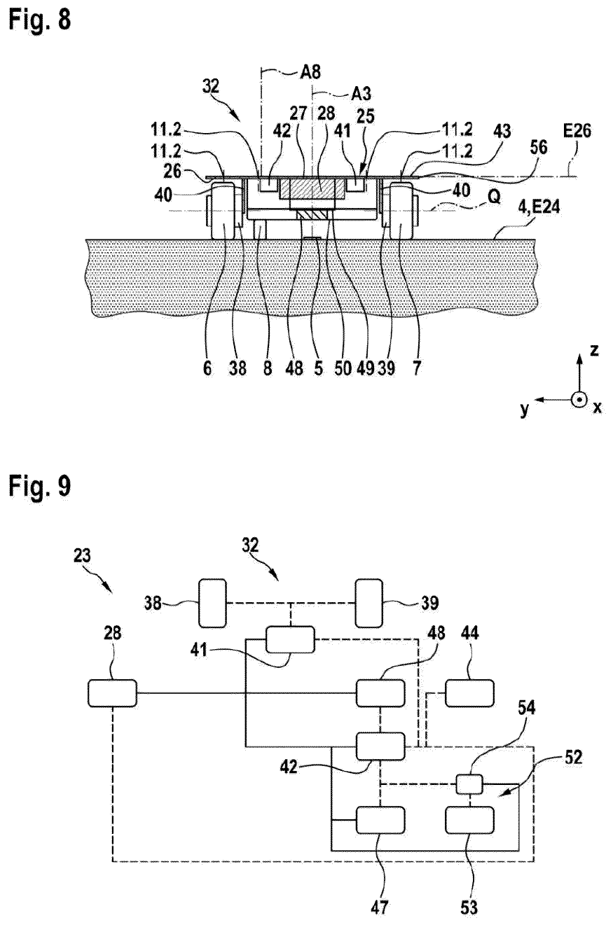

FIGS. 6 to 8 show the vehicle 3 according to the invention in detail, the circular contour of the container base 13 being indicated by dotted lines in FIGS. 6 and 7 merely in order to illustrate that, in the installed state, the vehicle 3 is substantially covered by the receiving container 2, or by the container base 13. It will be seen that only the electrical housing 22 as well as some components of an on-board electrical system 23 of the vehicle 3 that are arranged in or on the electrical housing 22 are located outside, or project beyond, the covered region.

Specifically, the vehicle 3 has an undercarriage 24 having the four wheels 6, 7, 8, 9, a vehicle body 25 supported by the undercarriage 24, a transport surface 26 with which the container base 13 of the receiving container 2 can be brought into contact, and the on-board electrical system 23 arranged on the vehicle body 25. Furthermore, the vehicle body 25 has a rigid base plate 27, the upper side of which, facing away from the undercarriage 24, comprises the transport surface 26. The base plate 27 has a circumferential surface 56 running around the yaw axis A3, which circumferential surface is configured so as to be exposed radially towards the outside and defines an outer edge 43 of the base plate 27. The transport surface 26 extends as far as the outer edge 43 of the base plate 27. The transport surface 26 lies in a support plane E26 which is parallel to the longitudinal direction X and to the transverse direction Y and to which a yaw axis A3 of the vehicle 3 is normal. Outside the transport surface 26, i.e. towards the outside of the transport surface 26 radially with respect to the yaw axis A3, the vehicle 3 has no components in the support plane E26. The yaw axis A3 corresponds to the vertical axis of the vehicle. It is advantageous if the yaw axis A3 runs through the centre of gravity of the vehicle 3. The on-board electrical system 23 is arranged entirely underneath the support plane E26.

For fastening the receiving container 2 to the vehicle 3, the fastening means 11 further comprise vehicle-side fastening elements 11.2 which co-operate with the container-side fastening elements 11.1, i.e. they are oriented relative to one another, in such a way that in the installed state a container axis A2 of the receiving container 2 and the yaw axis A3 of the vehicle 3, which yaw axis is fixed relative to the vehicle, coincide. The vehicle-side fastening elements 11.2 can comprise through-bores which are formed in the base plate 27 and especially in the region of the transport surface 26 and into which the container-side threaded bolts 11.1 are insertable. In the installed state, the threaded bolts 11.1 are installed in the through-bores 11.2 and the nuts 11.3 are screwed onto the threaded bolts 11.1 from below in order to clamp the container base 13 and the base plate 27 against one another.

The on-board electrical system 23 is shown diagrammatically in FIG. 9. It has an electrical energy storage means 28, which is permanently installed in the vehicle 3, especially a battery, and a charging interface 29 for charging the energy storage means 28 at an external charging station. It will be understood that the energy storage means 28 can be exchanged in the event of a defect. The charging interface 29 can be arranged in the electrical housing 22 so as to be accessible from the outside. The electrical housing 22 is mounted on the vehicle body 25 and can be made from a dimensionally stable plastics material. Preferably, the electrical housing 22 has a concave end face 30 as indicated by the dotted line in FIGS. 6 and 7. The curvature of the end face 30 is at least approximately the same as, but opposite to, the curvature of the side wall 12. This is advantageous if the driverless transport device 1 comes into contact with another driverless transport device 1 or with a standard can, because the other can will be able to rest against the curved end face 30. This may be the case, for example, in a can changer if the driverless transport device 1 is pushed against another can (“can against can” principle). Furthermore, an on/off switch 31 can be arranged on the electrical housing 22 so as to be accessible from the outside in order that the power supply between the energy storage means 28 and the other components of the on-board electrical system 23 can be interrupted manually.

Furthermore, the on-board electrical system 23 comprises an electrically operated drive unit 32, which, here by way of example, is in driving connection with the wheels 6, 7. The two wheels 6, 7 are in the form of fixed wheels which are aligned in the longitudinal direction X and are arranged spaced apart from one another in the transverse direction Y. They have rotational axes 33, 34 which are fixed in relation to the vehicle body 25 and lie on a notional straight line to which the yaw axis A3 of the undercarriage 3 is normal. It can be seen in FIGS. 6 and 7 that the notional straight line and the diagonal D2 of the container base 13 indicated by a dashed line are parallel to one another and lie in a common plane. The notional straight line divides the vehicle body 25 in the longitudinal direction X into a front portion 35 and a rear portion 36. The two portions 35, 36 can be of equal size, so that the notional straight line lies in a centre plane E3 defined by the vehicle transverse axis Y and the yaw axis A3. The vehicle body 25 can be symmetrical with respect to the centre plane E3. The electrical housing 22 is mounted on the rear portion 36 and projects beyond a rear edge 37 of the vehicle body 25.

The drive unit 32 comprises an electric motor 38, 39, especially a wheel hub motor, for each fixed wheel 6, 7. The electric motors 38, 39 in the form of wheel hub motors can be integrated in the fixed wheels 6, 7. The electric motors 38, 39 are arranged on housing struts 40 of the vehicle body 25 that project from the base plate 27, so that the fixed wheels 6, 7 remain behind the support plane E26. Furthermore, the drive unit 32 has, here by way of example, a servo converter for each electric motor 38, 39, which servo converters are here structurally combined in a double converter 41. Instead of servo converters it would also be possible to use frequency converters or other means for achieving the assigned rotational speed of the electric motors 38, 39. The double converter 41 is connected to the two electric motors 38, 39 and to the electrical energy storage means 28. By means of the double converter 41 it is possible for the two electric motors 38, 39 to be operated in the same or opposite directions and at the same or different rotational speeds to one another. The vehicle 3 can thereby be steered and, in the case of actuation in opposite directions, also turned on the spot, that is to say about the yaw axis A3. To control the electric motors 38, 39, the double converter 41 is connected to a control unit 42 of the on-board electrical system 23.

The control unit 42, which is a memory-programmable controller having a programmable storage medium, is configured for controlling the vehicle 3. Here by way of example it is in the form of a single device and is housed in a control housing. The control housing is fastened to the vehicle body 25, especially to the underside of the base plate 27. For monitoring the energy storage means 28, the on-board electrical system 23 can have a battery management system. For that purpose, the control unit 42 can be connected to the energy storage means 28. For communication with a higher-level master controller, with a textile machine or with a mobile device (smartphone, tablet, etc.), the control unit 42 can be connected to a radio module 44, which can be housed in the electrical housing 22.

Furthermore, the on-board electrical system 23 has a reading unit 45 which is configured for detecting the guide elements 5 arranged on the underlying surface. The reading unit 45 is preferably arranged exclusively on a function portion 46 of the vehicle body 25, which function portion is formed in the transverse direction Y between the two fixed wheels 6, 7. The function portion 46 has a width B46, i.e. an extent in the transverse direction Y, of at least 250 millimetres and at most 1200 millimetres and extends in the longitudinal direction X over the front portion 35 and the rear portion 36. The vehicle 3 is thus dimensioned for the transport of the receiving container 2 which, here, is configured as a “round can”. In order to be installable on a receiving container 2 in the form of a “rectangular can”, the vehicle 3 should be dimensioned correspondingly smaller. In that case the function portion 46 can also have a width of at least 150 millimetres and at most 1200 millimetres.

The reading unit 45 comprises a magnetic tape reading device 47, which is configured for contactlessly detecting of the course of guide elements 5 in the form of magnetic tapes 5.1. The magnetic tape reading device 47, which can also be referred to as a magnetic scanner, is arranged at an end of the vehicle body 25 that is located at the front in the main direction of travel (forward travel), i.e. in the longitudinal direction X. The magnetic tape reading device 47 has a sensor housing in which a plurality of sensors, for example eight sensors, are arranged spaced apart from one another in the transverse direction Y. The sensor housing can have a width, i.e. an extent in the transverse direction Y, of between 50 millimetres and 200 millimetres. The spacing of the sensors from the underlying surface, i.e. from a wheel contact plane E24 defined by the wheels 6, 7, which plane coincides with the floor plane during travel over the underlying surface 4, can be between 20 millimetres and 50 millimetres. The width of the magnetic strips can be between 6 and 50 millimetres.

Furthermore, the reading unit 45 has a RFID tag reading device 48 which is configured for reading out information from guide elements 5 in the form of RFID tags 5.2. The RFID tag reading device 48 can also be referred to as a RFID reader. The RFID tag reading device 48 is arranged below the base plate 27 on a frame 49, which is fastened to the base plate 27, in order that, during operation of the vehicle 3, the RFID tag reading device 48 is kept closely above the underlying surface 4, especially above the guide elements 5.2. The frame 49 engages around, here, the energy storage means 28, which is accordingly arranged between the base plate 27 and the RFID tag reading device 48 in the vertical direction Z. By means of the RFID tag reading device 48, address information, for example, can be read out from the RFID tags 5.2 and transmitted to the control unit 42. The RFID tags 5.2 usually have a diameter of less than 50 millimetres. To protect the on-board electrical system 23, an underbody panel 50 is arranged on the vehicle body 25 from below, which underbody panel can have an opening 51 in the region of the RFID tag reading device 48.

It can be seen in FIG. 7 that the wheels 8, 9 in the form of support wheels are arranged, i.e. supported on the vehicle body 25, eccentrically and between the two fixed wheels 6, 7 in the transverse direction Y. Their transverse spacing from the longitudinal axis L of the vehicle is, here by way of example, about 90 millimetres in each case, so that the two support wheels 8, 9 are spaced about 180 millimetres apart from one another in the transverse direction Y. The function portion 46 is formed between the support wheels 8, 9 and is accordingly free of the wheels 6, 7, 8, 9 in order to protect the guide elements 5 during operation of the driverless transport device 1. In principle, however, it is also possible for the support wheels 8, 9 to be arranged centrally, that is to say on the longitudinal axis L of the vehicle.

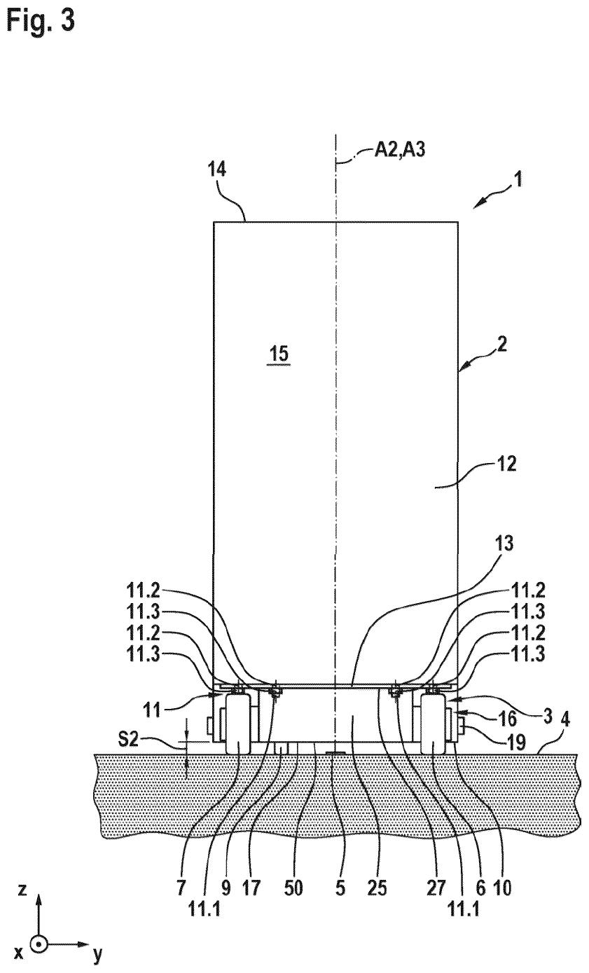

Each of the support wheels 8, 9 is mounted on the vehicle body 25 so as to be pivotable about its own pivot axis A8, A9 which is aligned parallel to the vertical axis Z. The support wheels 8, 9 can be freely pivotable about the pivot axes A8, A9, so that they are able to pivot through 360 degrees and more. Support wheel 8, which can also be referred to as the leading support wheel, is supported on the front portion 35 and support wheel 9, which can also be referred to as the trailing support wheel, is supported on the rear portion 36. The leading support wheel 8 is not spring-mounted and the trailing support wheel 9 is spring-mounted on the vehicle body 25. To improve the stability of the vehicle 3, the support wheels 8, 9 can be arranged as far as possible to the outside on the vehicle body 25 and, as shown merely by way of example by the dotted line 57 in FIG. 3, can lie on a notional circular line. In principle, however, it is also possible for the support wheels 8, 9 to be arranged at different spacings to one another from the centre plane E3 in which the two rotational axes 33, 34 lie. It is advantageous if the centre of gravity of the vehicle 3 lies in the centre plane E3 in which the transverse axis Q of the vehicle also runs.

The vehicle 3 has an overall height H3 of, here by way example, 140 millimetres. The transport surface 26 finishes the vehicle 3 towards the top. Accordingly, the overall height H3 is determined by the spacing of the transport surface 26 from the underlying surface 4, i.e. from the wheel contact plane E24.

The vehicle 3 therefore has a compact design such that, in the installed state, it at least substantially disappears below the receiving container 2, i.e. below the container base 13 thereof. Only individual components, especially from the on-board electrical system 23, are able to project laterally beyond the container base 13, because there is a technical necessity therefor. Those components can be, for example, the charging interface 29, the on/off switch 31 and the radio module 44, which are arranged in or on the electrical housing 22. In the installed state, the undercarriage 24, the electrical drive unit 32, the electrical energy storage means and the transport surface 26 are therefore entirely covered. Furthermore, as can be seen in FIGS. 1 to 8, the receiving container 2, or its container base 13, can also entirely cover the base plate 27 as well as the fastening elements 11 and can at least substantially cover the on-board electrical system 23. Of the on-board electrical system 23, in particular the control unit 42 and the reading unit 45 can be covered.

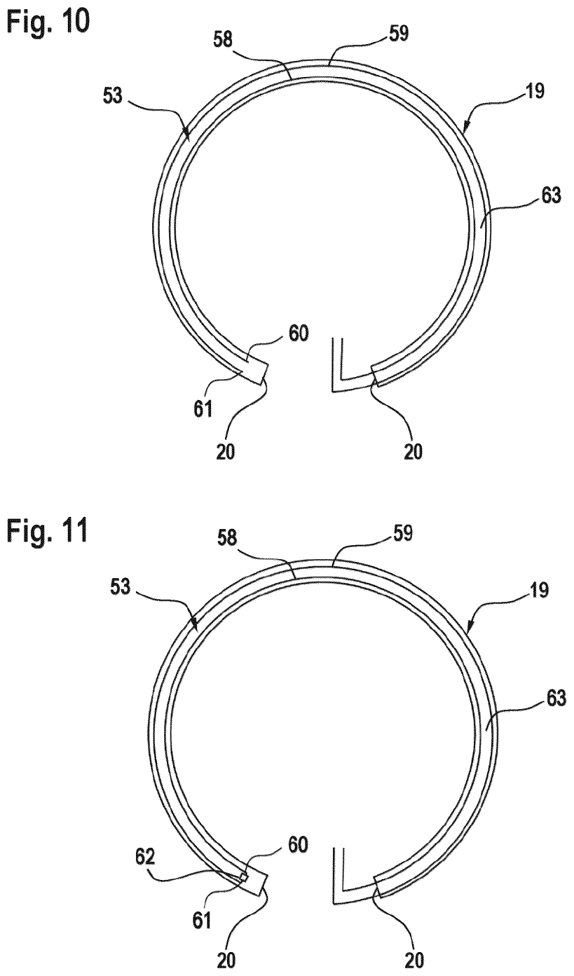

Furthermore, the on-board electrical system 23 can have a safety device 52 for impact detection. This can have components that are located outside the region covered by the receiving container 2 in order that a collision or impact with an obstacle located in the route of the driverless transport device 1 can be detected as early as possible. For example, a contact sensor 53 can be integrated in the bumper 19, which contact sensor is connected to the control unit 42, in order to stop the vehicle 3 if an impact is detected. The bumper 19, here, has a c-shape and the electrical housing 22 projects radially outwards between the two ring ends 20. Accordingly, the end face 30 of the electrical housing 22 can be utilised to move another can by being able to bear against the side wall thereof (“can against can” principle”). The safety device 52 can comprise a safety relay 54 in order to monitor the existence of the connection between the contact sensor 53 and the control unit 42. If the contact sensor 53 is not correctly connected, the control unit 42 can on safety grounds block or stop the drive unit 32. As a result, the contact sensor 53 can be configured like a closing contact (normally-open contact) which is closed only on impact with an obstacle. For that purpose, the bumper 19 can have a damping element 63 made of a flexible material, which damping element extends in the circumferential direction around the yaw axis A3 of the vehicle 3, the contact sensor 53 being arranged in the damping element 63. The damping element 63 is preferably resiliently compressed locally by the impact energy on impact with the obstacle and the contact sensor 53 housed in the damping element 63 generates a switching signal. Specifically, the contact sensor 53, as shown in FIG. 10, can have two wires 58, 59, one of which can be connected to the negative pole and the other of which can be connected to the positive pole of the energy storage means 28. The wires 58, 59, in the idle or normal state shown here, are arranged spaced apart from one another inside the bumper 19 up to and including their wire ends 60, 61. Only on impact with the obstacle, i.e. when subject to the impact energy, is the bumper 19 locally compressed, with the result that the outer wire 59 is displaced towards the inner wire 58 and touches the latter (collision state). As soon as the control unit 42 detects the switching signal, it initiates those specified safety measures, such as stopping the driverless transport device 1, for example by braking or stopping the vehicle 3 or the drive unit 32. In principle, however, it is also possible to use a normally-closed contact instead of the cost-effective normally-open contact.

For safety reasons it can be provided that the drive unit 32 is designed to drive the vehicle 3 over the underlying surface 4 at a travel speed of at most 0.5 metre per second and more preferably of at most 0.3 metre per second. Furthermore, the drive unit 32 can be designed to provide the maximum travel speed up to a total weight of at most 200 kilograms.

It can be seen in FIGS. 6 and 7 that the surface area of the base plate 27 is smaller than that of the container base 13. The base plate 27 can have the shape of a polygon in plan view and here, merely by way of example, is in the shape of an octagon, that is to say with eight corners and eight sides. In the four corner regions that are formed with respect to the round container base 13, in which regions the container base 13 projects beyond the base plate 13, it is possible for bores (not shown) to be formed in the container base 13, through which smaller sliver oddments that collect in the filling space 15 or other contaminants can drop downwards through the equipment space 16 and fall onto the underlying surface 4. The bores are preferably formed between the respective fixed wheel 6, 7 and the function portion 14.

FIG. 11 shows an alternative embodiment of the contact sensor 53 in which the two wire ends 60, 61 of the wires 58, 59 are connected to one another via an electrical resistance 62. In this embodiment the on-board electrical system 23 does not require a safety relay 54. One of the two wires 58; 59 can be connected to an input and the other of the two wires 59; 58 can be connected to an output of the control unit 42. If the contact sensor 53 has been correctly connected (idle or normal state), the resistance between the input and the output corresponds to the magnitude of the electrical resistance 62, which can be, for example, 8 kiloohms. If the two wires 58, 59 make contact with one another locally on impact with the obstacle (collision state), the resistance between the input and the output falls to a value close to zero (“short circuit”). In that way the contact sensor 53 can generate the switching signal on the basis of which the control unit 42 recognises the impact and can initiate the measures. If, however, the contact sensor 52 is not correctly connected or one of the wires 58, 59 is broken, then the resistance between the input and the output will be infinitely high. The control unit 42 can then block or stop the drive unit 32 on safety grounds.

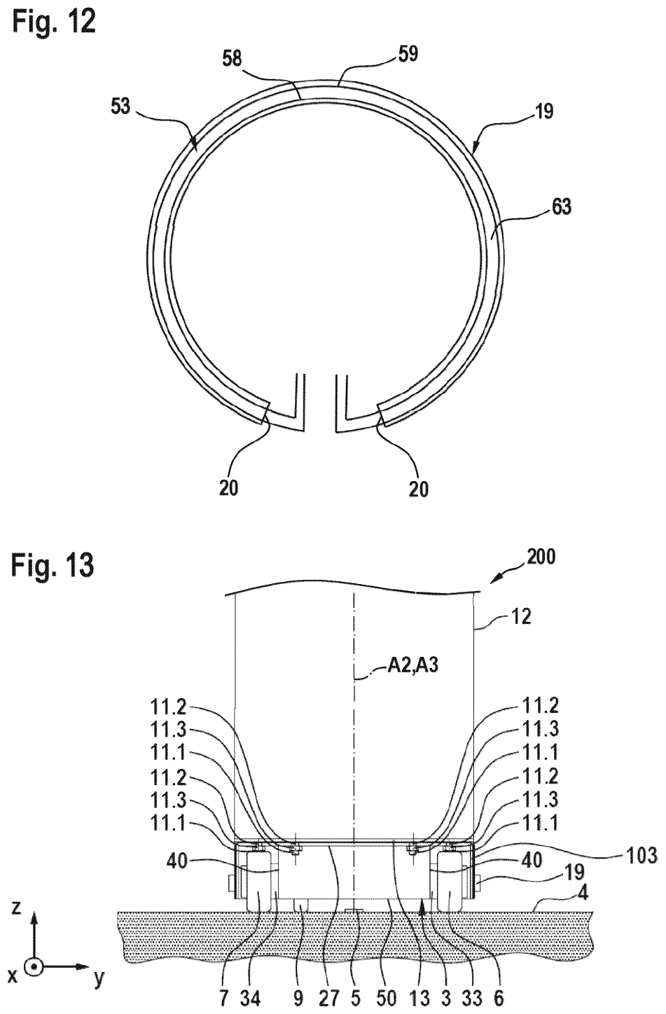

FIG. 12 shows a further embodiment of the contact sensor 53 in which the two wires 58, 59 each individually form a closed circuit. For that purpose, the wires 58, 59 are connected to inputs and outputs of the control unit 42. This monitors whether the circuit formed by the respective wire 58, 59 is closed (idle or normal state). If the contact sensor 53 is not correctly connected or one of the wires 58, 59 is broken, this is registered by the control unit 42. The control unit 42 can then block or stop the drive unit 32 on safety grounds. If the two wires 58, 59 make contact with one another locally on impact with the obstacle (collision state), the control unit 42 recognises the impact and can initiate the safety measures.

FIG. 13 shows a driverless transport device 200 in accordance with a second embodiment of the present invention which largely corresponds to that of FIGS. 1 to 12, so that in respect of the common features reference is made to the description above; identical or modified details have been given the same reference signs as in FIGS. 1 to 12. The difference lies in the arrangement of the bumper 19 with the integrated contact sensor 42. The bumper 19 is, here, fastened to the vehicle 3.

For the sake of clarity, the receiving container 202 is shown cut off towards the top. FIG. 13 shows the installed state. The receiving container 202 has a sleeve-like basic shape, wherein the container base 13 finishes flush with the underside of the receiving container 202. Accordingly, the receiving container 202 does not have an equipment space in which the vehicle 3 can be installed. Rather, the receiving container 202 is mounted in planar contact with the base plate 27 of the vehicle 3. As shown in FIG. 3 in connection with the first embodiment, the fastening means 11 are concealed by the receiving container 2. The container-side fastening elements 11.1 are, here by way of example, likewise in the form of threaded bolts which are aligned parallel to the container axis A2 and extend through vehicle-side fastening elements in the form of through-bores formed in the base plate 27 and especially in the region of the transport surface 26. On the underside of the base plate 27, nuts 11.3 are screwed onto the threaded bolts 11.1 in order to clamp the container base 13 against the base plate 27.

The bumper 19 is arranged on the vehicle 3. For that purpose, the vehicle 3 can have a collar 103 aligned parallel to the yaw axis A3, which collar can be formed integrally with the base plate 27 and can project downwards therefrom. The bumper 19 can be fastened to the collar 103 from the outside. The contact sensor 53 can be integrated in the bumper 19, as described in the embodiments in relation to FIGS. 10 to 12.

Reference signs

| | | | |
|---|---|---|---|
| 1, 200 | transport device | 46 | function portion |
| 2, 202 | receiving container | 47 | magnetic tape |
| | | | reading device |
| 3 | vehicle | 48 | RFID tag reading device |
| 4 | underlying surface | 49 | frame |
| 5 | guide element | 50 | underbody panel |
| 6 | wheel, or fixed wheel | 51 | opening |
| 7 | wheel, or fixed wheel | 52 | safety device |
| 8 | wheel, or support wheel | 53 | contact sensor |
| 9 | wheel, or support wheel | 54 | safety relay |
| 10 | container underside | 55 | junction |
| 11 | fastening means | 56 | circumferential surface |
| 12 | side wall | 57 | circular line |
| 13 | supporting structure | 58 | wire |
| 14 | filling opening | 59 | wire |
| 15 | filling space | 60 | wire end |
| 16 | equipment space | 61 | wire end |
| 17 | container opening | 62 | resistance |
| 18 | base underside | 63 | damping element |
| 19 | bumper | | |
| 20 | ring end | 103 | collar |
| 21 | wall opening | | |
| 22 | electrical housing | | |
| 23 | on-board electrical system | | |
| 24 | undercarriage | | |
| 25 | vehicle body | | |
| 26 | transport surface | | |
| 27 | base plate | | |
| 28 | energy storage means | | |
| 29 | charging interface | | |
| 30 | end face | | |
| 31 | on/off switch | | |
| 32 | drive unit | | |
| 33 | rotational axis | | |
| 34 | rotational axis | A | axis |
| 35 | front portion | B | extent in transverse |
| | | | direction, or width |
| 36 | rear portion | D | diameter or diagonal |
| 37 | rear edge | E | plane |
| 38 | electric motor | F | main direction of travel |
| 39 | electric motor | H | extent in vertical |
| | | | direction, or height |
| 40 | housing strut | L | vehicle longitudinal axis |
| 41 | double converter | S | spacing |
| 42 | control unit | Q | vehicle transverse axis |
| 43 | outer edge | X | longitudinal direction |
| 44 | radio module | Y | transverse direction |
| 45 | reading unit | Z | vertical direction |

1. A driverless transport device comprising:
a self-driving vehicle for transporting a receiving container for a fibre sliver over an underlying surface between sliver-delivering and sliver-fed textile machines, wherein the vehicle comprises:
an undercarriage with a plurality of wheels;
a vehicle body supported by the undercarriage and including a transport surface for the receiving container;
fastening elements for fastening the receiving container to the vehicle body;
an on-board electrical system arranged on the vehicle body and including an electrical energy storage means, an electrical drive unit and a control unit, wherein the electrical system is arranged on the vehicle body; and
a safety device for impact detection arranged on the vehicle, the safety device being in signalling communication with a control unit and generating a switching signal on impact with an obstacle;
wherein the vehicle is dimensioned so that in an installed state, in which the receiving container is in contact with the transport surface and is fastened to the vehicle body, the receiving container entirely covers the undercarriage, the electrical drive unit and the electrical energy storage means.

2. The driverless transport device according to claim 1, wherein the transport surface defines a support plane, and the vehicle has no components outside the transport surface that project beyond the support plane.

3. The driverless transport device according to claim 1, wherein the transport device comprises the receiving container which is mounted on the transport surface of the vehicle and is fastened to the vehicle body so that the receiving container entirely covers the undercarriage, the electrical drive unit and the electrical energy storage means (28).

4. The driverless transport device according to claim 3, wherein the transport device comprises a bumper which projects, facing outwards, beyond the receiving container, wherein the bumper is fastened to the receiving container.

5. The driverless transport device according to claim 1, wherein the vehicle has a collar and the transport device comprises a bumper fastened to the collar of the vehicle.

6. The driverless transport device according to claim 5, wherein the safety device has a contact sensor accommodated in the bumper.

7. The driverless transport device, according to claim 6, wherein the bumper includes a damping element made of a flexible material, wherein the damping element extends in the circumferential direction around a vertical axis of the vehicle, and the contact sensor is arranged in the damping element.

8. The driverless transport device according to claim 6, wherein for generating a switching signal the contact sensor comprises a normally open contact configured to close a contact in an event of impact with the obstacle.

9. The driverless transport device according to claim 6, wherein for generating a switching signal the contact sensor comprises a normally closed contact configured to open a contact in the event of collision with the obstacle.

10. The driverless transport device according to claim 4, wherein the wheels define a wheel contact plane (E24), and the bumper is arranged at a spacing of at least 10 millimetres and at most 40 millimetres above the wheel contact plane.

11. The driverless transport device according to claim 4, wherein the bumper has a c-shaped open ring shape having two ring ends, wherein a charging interface for charging the energy storage means is arranged between the ring ends.

12. The driverless transport device according to claim 11, wherein the charging interface projects laterally beyond the bumper and is arranged in a dimensionally stable electrical housing, wherein an end face of the electrical housing is concavely curved.

13. The driverless transport device according to claim 1, wherein the control unit is configured to monitor a power consumption of the drive unit and to stop the drive unit if a defined threshold value is exceeded.
